(19) United States
(12) Patent Application Publication
(10) Pub. No.: US 2009/0028309 A1
(43) Pub. Date: Jan. 29, 2009

(54) Method and apparatus for portable, source independent, low cost telephonization

(76) Inventor: Hang Deng, Aliso Viejo, CA (US)

Correspondence Address: Abraham N. Seidman, P. O. Box 16603, Beverly Hills, CA, 90209, US

(21) Appl. No.: 11/881,106

(22) Filed: Jul. 24, 2007

(51) Int. Cl. H04M 15/00

(52) U.S. Cl. 379/114.03; 379/114.2

(57) ABSTRACT

The present invention utilizes a message which can be sent from any suitable source for an appropriate message. The basic message includes a pin number, the desired telephone from which the caller intends to talk. This caller may intend his own cell-phone or another's cell phone or any other telephone to be the originating telephone. Included in the message is the destination telephone number. The message is sent to a service center which verifies the pin number and sets up to charge the pin associated pre-paid or open account. Upon verification, a switch is set with the destination telephone number in its switch calling memory. Upon setting up the switch for the call, a call is placed to the intended originating telephone. When that telephone is answered, the destination telephone number is called.

The basic message may be an SMS, an e-mail or sent from a web-site which is provided for the service center. In the future, additional suitable sources may also available.

Provision may be made for automatically re-calling the originating telephone and/or the destination phone, in the event either telephone is not answered immediately.

### FIELD OF THE INVENTION

This invention relates to originating telephone calls utilizing messages containing a portable pin number which is independent of a source, e.g., a preregistered telephone.

This invention relates to very low cost telephone service.

### BACKGROUND OF THE INVENTION

There is a long-standing need for low-cost simple telephone service between family members, between business contacts and between the citizens of the world. Currently, many countries maintain a telephone monopoly on calls originating from the country, charge very high rates for outgoing calls from the country. They do not, however, burden incoming calls to their citizens with a charge. It would be desirable to make a call out of these countries as inexpensive as calling into these countries.

Previous attempts at providing such a service require pre-registration of the calling phone and/or prior registration of the called phones and/or limit the caller to a certain phone, with a severe loss of freedom and simplicity of making a call from wherever one might be. There is a need for a convenient low-cost phone service, not just for a low cost service. A goal would be to achieve a low cost phone service as convenient as making an ordinary telephone call. The invention herein does this.

If you are on a beach in Thailand and a tidal wave washes away your cell phone, you have a need to try to reach international rescue services and to notify those close to you that you are safe, this invention summarized below, allows you to borrow someone's cell phone and make a low cost call to your relatives, say in London, and your friends in Paris and Rome, at a very low cost. The invention herein does this.

If you just get to the airport in New Dehli and you have forgotten your cell phone, or its batteries have run down, and you want to let your business associate know that you will be landing in Sydney airport an hour later than planned, you just borrow your friend cell phone and make the low cost call. The herein invention does this.

If your account with the service provider has run down, or you don't have an account, you can conveniently buy a pre-paid pin card which contains a pin number and allows for a caller to make pin-based calls up to the value of the card. The invention herein does this.

Additionally, of course, as part of the ultra-portability of the invention herein, you can purchase a brand new pin or you can recharge your existing pin value. This can be done by sending a customer service SMS message and having the service call to you, thus providing a securable link for pin value updating. The invention herein does this.

Immediately upon purchasing your pin card, you are ready to call a loved one and express your feelings to them. It's very easy and low cost to stay in touch.

Looking at prior related art, Shinohara et al. (U.S. Pat. No. 5,351,237—September 1994); Hau, (U.S. Pat. No. 5,661,790 A—August 1997), Brachman et al. (U.S. Pat. No. 6,374,102 B1—April 2002); Dunn, et al. (U.S. Pat. No. 6,463,144 B1—October 2002); Johnson et al. (November 2002) and Jorash et al. (US 2003/0002642 A1 January 2003) reached a system where the caller could send an e-mail with his/her phone number to a callback system which, after cross-referencing the phone and the phone number, then calls back the caller's registered phone number. At that point the caller dialed the phone he/she wishes to call and is connected via the callback service to the destination phone. Boursan improved the procedure (U.S. Pat. No. 7,146,163 B2—filed October 2002, granted December 2006) by eliminating the need for the caller to dial the destination phone number after the call-back service. However, Bousan required a phone which was already registered with his service; it didn't provide for source-independent portability to and from any phone, anywhere.

In the current invention a complete degree of portability and freedom from any particular phone, so the current method is source independent or “source-free”. This makes a vast improvement over a system where your ability to make low cost world-wide calls now does not depend on having an easily lost, easily damaged and easily in a dead battery state—a particular cell-phone. You can go to a local shop, purchase a pre-paid phone and immediately receive a pin number using a debit card, and you are good to go in very real time. You can even purchase a pre-paid pin card together with a pre-paid phone. Going into a store you are without communication ability. Coming out of the store you have global, low-cost access. This is extremely convenient in normal everyday life, but can also literally be a life-saver under critical circumstances. The invention herein provides for that.

One of the major deficiencies that has inhibited the growth of the services of the prior art is the necessity of tying the service to a specific object, a particular pre-registered telephone. With the present invehtion, the service improvement is such a leap forward in convenience and applicability, that this invention will answer a long felt need and provide explosive international growth in this service.

### SUMMARY OF THE INVENTION

The present invention utilizes a message which can be sent from any suitable source for an appropriate message. It is source independent, free of reliance on any particular device, such as a pre-registered telephone. The basic message includes a pin number, the desired telephone from which the caller intends to talk. This caller may intend his own cell-phone or another's cell phone or any other telephone to be the originating telephone. Included in the message is the destination telephone number. The message is sent to a service center which verifies the pin number and sets up to charge against the pin value. Upon verification, a switch is set with the destination telephone number in its switch calling memory. Upon setting up the switch for the call, a call is placed to the intended originating telephone. When that telephone is answered, the destination telephone number is called immediately.

The basic message may be an SMS, an e-mail or sent from a web-site which is provided for the service center. In the future, additional suitable sources may also available.

Provision may be made for automatically re-calling the originating telephone and/or the destination phone, in the event either telephone is not answered immediately. Provision may also be made for scheduling a call at a later time.

Additionally the invention provides for pre-paid pin value cards. The availability of pre-paid pin value cards increases the availability and convenience of this telephone service.

The invention also provides for a pre-paid pin value set up with the service and/or value added later, according to methods known in the art.

For businesses, a set of pins can be distributed to the business which in turn distributes them to its employees. The master pin value of the business reflects the pin values used by its employees as they make their calls and a periodic billing of business for its master pin value decrement can be issued to the user business.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1a diagrams first prior art;

FIG. 1b diagrams second prior art.

FIG. 2 depicts the steps of the operation of the invention;

FIG. 3a shows the initiating message step;

FIG. 3b shows the pin verification steep;

FIG. 3c shows the completing call to the destination telephone as the originating telephone is being called;

FIG. 4 shows the invention as an apparatus;

FIG. 5a shows a person 501 (not part of the invention) without low-cost global communications;

FIG. 5b shows person (not part of the invention) buying a pre-paid pin card;

FIG. 5c shows two happy people (not part of the invention) enabled, by the pre-paid pin card, having a low-cost intercontinental conversation.

### DETAILED DESCRIPTION OF THE BEST MODE

The invention represents a method for providing a source independent low-cost telephone service. It can also be cast as an apparatus which performs the steps of the method. Also, the steps of the method can be first fixed in a computer readable media as an instruction set and read by the CPU of a computer so that the instruction set is carried out.

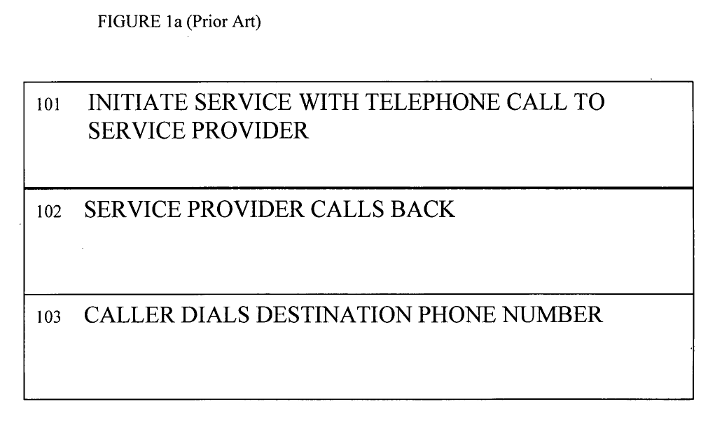

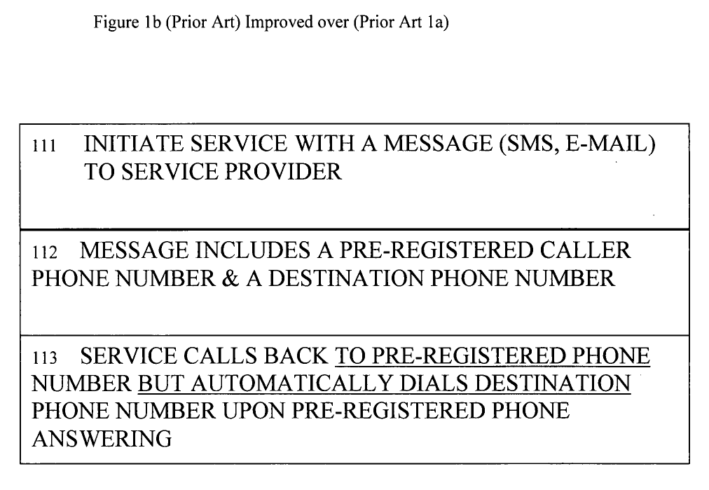

FIG. 1a shows first prior art where a telephone call to a service telephone number 101 is needed to initiate a call back 102 from the service, and when the originating telephone is answered, the caller must then additionally dial the destination phone number 103 service.

FIG. 1b shows later prior art. A message to the service can be used to initiate the service 111. The message must include a pre-registered caller phone number and a destination phone number 112. The service automatically dials the destination number but the service calls back only to a pre-registered origination phone number.

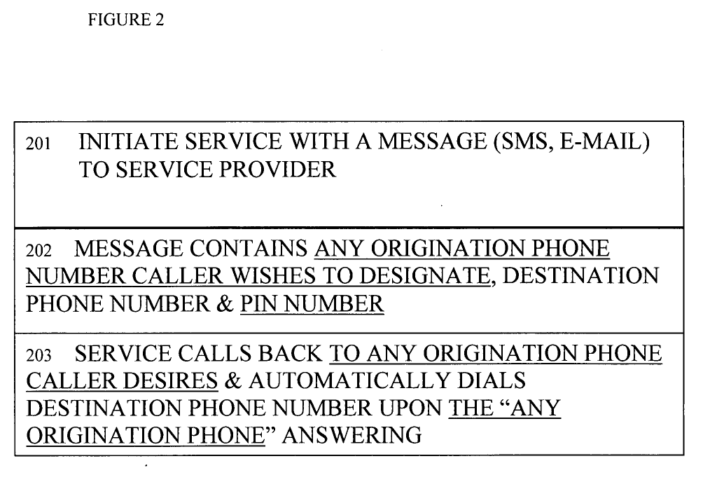

The invention herein (see FIG. 2) initiates the service by sending a message to the service 201, typically by SMS (short message service). The message contains a destination phone number 202, but also an origination phone number 202, which can be any phone chosen by the call originator and does not have to be pre-registered. The message also contains a pin number 202.

The services calls back to the “any” call originator designated phone number 203 and not to just a registered phone number. The service automatically dials the destination phone number 203 upon the “any” call originator designated phone number 203.

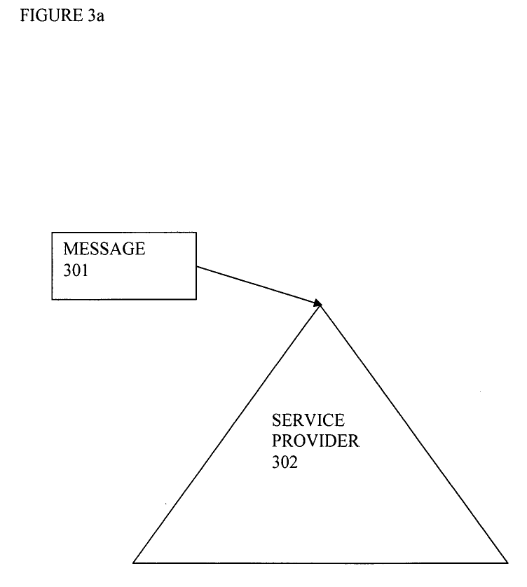

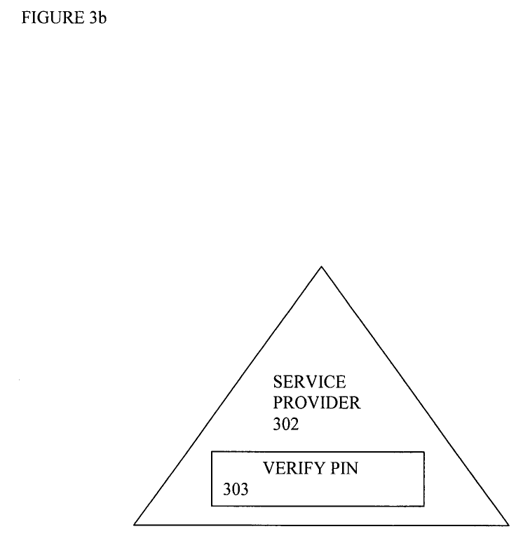

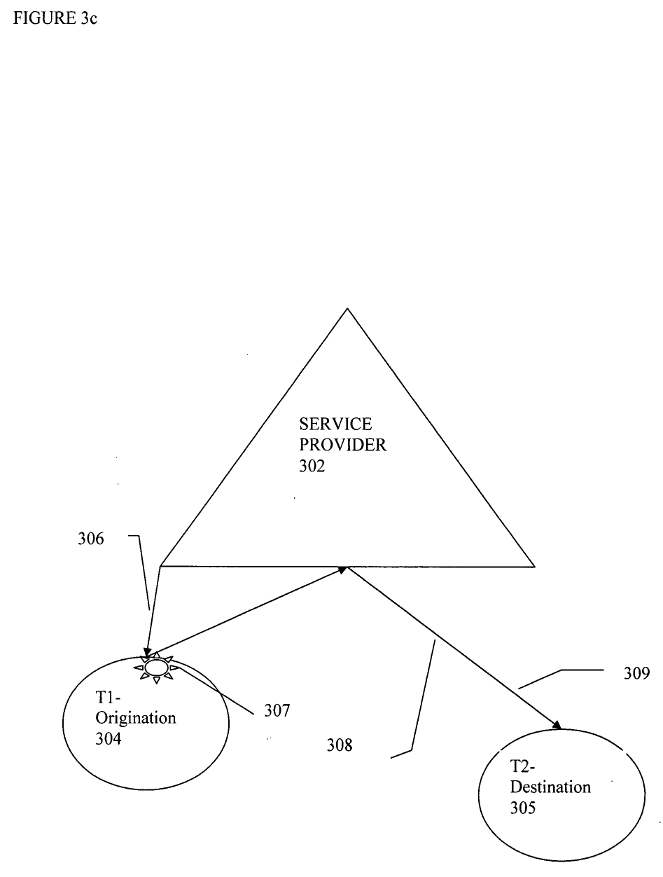

FIG. 3a shows the initiation of service by a message 301 to the service provider 302.

FIG. 3b shows the verification function 303 performed by the service provider 302.

FIG. 3c shows the service provider 302 initiating a call to the “any originator designated phone number T1 304. The switching mode function 310 for the call being made is set up by the service provider 302. Upon the “any” originator designated phone answering 307, the originating caller T1 304 hears the destination phone T2 305 being dialed and the call routing is completed when the destination phone T2 305 answers 311.

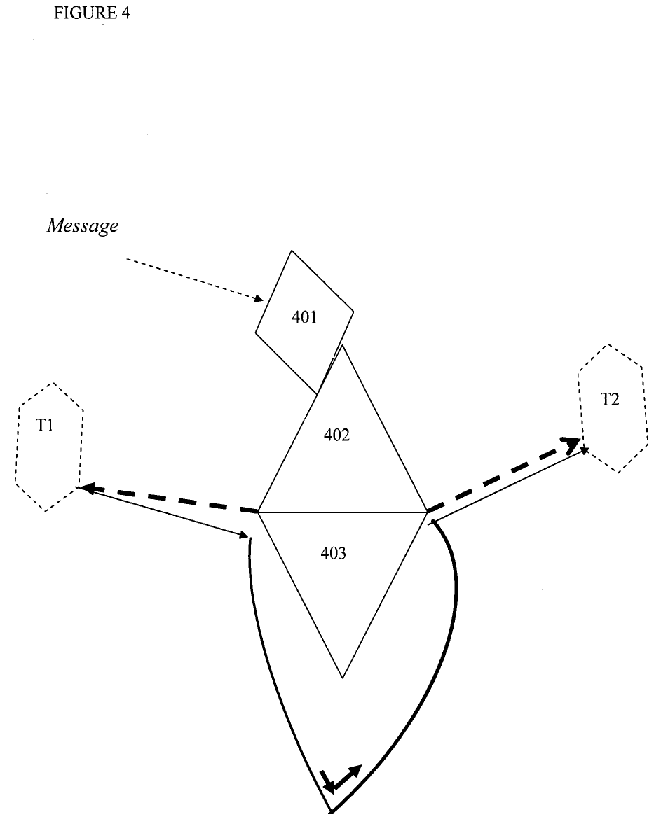

FIG. 4 shows the apparatus including a message receiving means 401, a computer means 402 and a switching means 403. The computer means 402 contains instructions fixed in a computer readable media and carries out all the functions, I,e, instructions, of the method herein. Functions of the computer 402 include decoding the incoming message, verifying the pin number, setting a switch with the destination phone number in its memory and calling the designated “any phone number” ad detecting the answering of that phone and completing the telephone route to the destination phone T2. The pin number may be encrypted to enhance security.

The value of the pin number is decremented in real time, as determined by a service provider rate plan, which may include originator phone location, destination phone location, and length of call and time of day of placing call as parameters in the rate calculation. The pin values may be pre-paid. For a business, an open charge for pin values, for the pin numbers assigned to the business's employees, may be included by the service provider. Message initiated (typically SMS) customer service calls to an originator's “any” designated phone number may be provided by the service provider.

As well as normal remote means of maintaining a pin value, additionally, pre-paid pin number cards may be sold for accessing the service. These may be sold in stores and at locations in an airport, for example. This just adds to the convenience and portability provided by the invention herein.

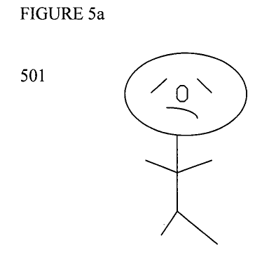

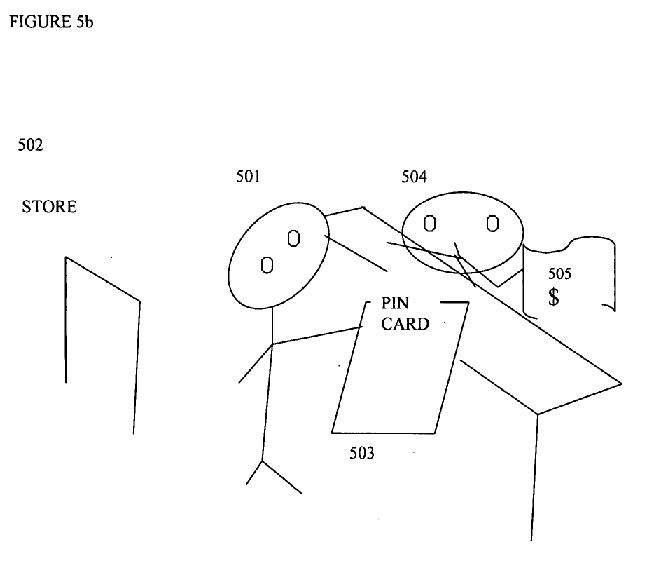

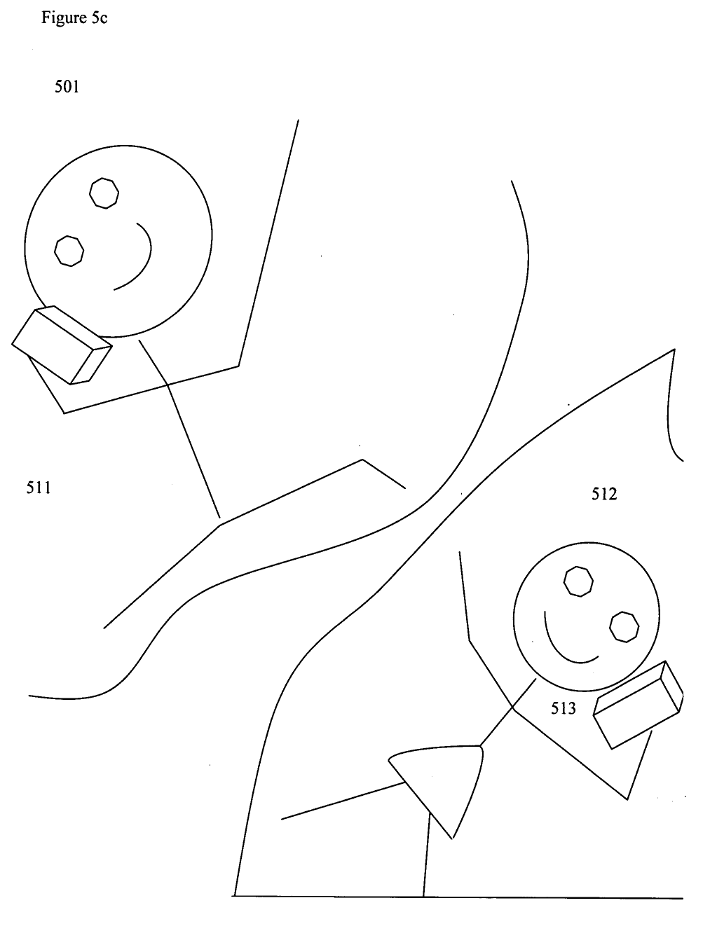

FIG. 5a shows a person 501 (not part of the invention) without low-cost global communications;

FIG. 5b shows person 501 (not part of the invention) buying 505 a pre-paid pin card 503 in a store 502 from a pin card vendor person 504 (person not part of invention)

FIG. 5c shows two happy people (not part of the invention) enabled, by the pre-paid pin card, having a low-cost intercontinental conversation

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention.

What is claimed is:

1. An method for providing low-cost telephone service, comprising:
receiving a stimulation message sent by a caller to a service provider service center wherein the stimulation message includes an identifying pin number and an intended originating telephone number and an intended destination telephone number;
decoding the caller-sent stimulating message and placing the pin number, the intended caller telephone number and the intended destination number into a stored mode of the service center;
verifying the identifying pin number;
setting up a charging mode against the pin-associated account;
placing the received and stored destination number in a switch which is switchable to call the destination telephone number;
calling the intended originating telephone number;
connecting the intended originating telephone and the intended destination telephone upon the intended originating telephone answering the call to it by the service center, wherein the caller hears the destination telephone ringing;
the caller completing telephone call to the destination phone when the intended destination telephone is answered;
recording a completed telephone call connection to the destination phone when the intended destination telephone is answered;
charging the caller by the service center the service center charges the pin-associated account according to a rate scale of the service center which may include the length of the call for calculating the charges.

2. A computer readable set of instructions, imbedded in a storage medium,
wherein said instruction cause a central processing unit or computer to perform the following operations upon receiving an external message originated by a caller containing an identifying pin number and an intended originating telephone number and a destination telephone number:
decoding the message to obtain the identifying pin number, the intended caller telephone number and the intended telephone caller number;
verifying the identifying pin number;
setting up a charging mode against the pin-associated account;
placing the received and stored destination number in a switch which is switchable to call the destination telephone number;
calling the intended originating telephone number;
connecting the intended originating telephone and the intended destination telephone upon the intended originating telephone answering the call to it by the service center, wherein the caller hears the destination telephone ringing;
recording a completed telephone call connection to the destination phone when the intended destination telephone is answered;
charging the caller by the service center the service center charges the pin-associated account according to a rate scale of the service center which may include the length of the call for calculating the charges.

3. An apparatus for providing low-cost telephone service, comprising:
a stimulating message wherein the stimulating message contains an identifying pin number and an intended originating telephone number and an intended destination telephone number;
a service provider service station wherein the service center has the capability to receive the stimulating message;
wherein the service center, upon receiving a stimulating message, decodes the message, reads and verifies the pin number, and wherein the service center sets up a charging mode against the pin-associated account and
wherein the service center decodes the intended destination telephone number and places the intended destination number in a switch which is switchable to call the destination telephone number, and
wherein the service center decodes the intended originating telephone number, and calls the intended originating telephone number,
and wherein upon the intended originating telephone answering the call to it by the service center, the service center then connects the originating telephone to the destination telephone, and
wherein the caller at the originating telephone, after a brief pause, hears the destination telephone ringing, and upon the destination telephone being answered, the telephone circuit is completed between the intended original telephone number and the destination telephone number, and
wherein the length of the call is recorded by the service center; and wherein the service center charges the pin-associated account according to a rate scale of the service center rate which may include the length of the call for calculating the charges.
